(19) United States
(12) Patent Application Publication
(10) Pub. No.: US 2015/0183300 A1
(43) Pub. Date: Jul. 2, 2015

(54) AIR VENT APPARATUS FOR VEHICLE

(71) Applicants: Hyundai Motor Company, Seoul (KR); NIFCO KOREA Inc., Asan-si (KR)

(72) Inventors: Hyuk Jae Kwon, Ansan-si (KR); Hong Kil NOH, Asan-si (KR)

(73) Assignees: Hyundai Motor Company, Seoul (KR); NIFCO KOREA Inc., Asan-si (KR)

(21) Appl. No.: 14/489,088

(22) Filed: Sep. 17, 2014

(30) Foreign Application Priority Data
Dec. 27, 2013 (KR) 10-2013-0164906

(51) Int. Cl. B60H 1/34; B60H 1/24

(52) U.S. Cl. CPC B60H 1/3414; B60H 1/246

(57) ABSTRACT

An air vent apparatus for a vehicle may include an outer wing integrated with a wing nozzle, a plurality of inner wings coupled to each other via a wing link, a spacer to which the wing nozzle may be fixedly coupled, the inner wings being rotatably coupled to the spacer, the spacer being rotatably coupled to the duct, and a knob coupled to the inner wings while being fitted to the outer wing, thus rotating the inner wings relative to the spacer.

The present application claims priority of Korean Patent Application Number 10-2013-0164906 filed on Dec. 27, 2013, the entire contents of which application are incorporated herein for all purposes by this reference.

### BACKGROUND OF THE INVENTION

1. Field of the Invention

The present invention relates to air vent apparatuses for vehicles, and, more particularly, to an air vent apparatus for a vehicle, which is configured so that a plurality of outer wings is integrated with each other by a wing nozzle.

2. Description of Related Art

FIGS. 1A and 1B show an example of an air vent 2 mounted to a vehicle dashboard 1. The air vent 2 functions to discharge cold or warm air, which is generated from an air-conditioning device, to an interior of a vehicle. The air vent 2 includes a duct 2a that guides an air flow to the interior of the vehicle, a plurality of inner wings 2b that are rotated to guide an air discharge direction leftwards and rightwards, a plurality of outer wings 2c that are rotated to guide the air discharge direction up and down, and a knob 2d that is manipulated to rotate the inner and outer wings 2b and 2c.

The inner wing 2b rotates leftwards and rightwards about each of hinges provided at upper and lower positions and is thus referred to as a vertical wing, whereas the outer wing 2c rotates up and down about each of hinges provided at left and right positions and is thus referred to as a horizontal wing.

The knob 2d is installed to be connected to both the inner and outer wings 2b and 2c. Thereby, when the knob 2d moves leftwards and rightwards, it moves leftwards and rightwards along the outer wing 2c, thus rotating the inner wing 2b leftwards and rightwards. On the other hand, when the knob 2d moves up and down, it rotates only the outer wing 2c up and down.

However, the conventional air vent 2 is problematic in that the plurality of outer wings 2c are connected to each other via a wing link (not shown) in such a way as to be integrally moved, so that the number of parts, manufacturing cost, and weight are inevitably increased due to the use of the wing link.

Further, in order to assemble the plurality of outer wings 2c with the wing link, a hinge protrusion should be formed on the outer wing 2c and a groove should be formed in the wing link. Such a configuration makes a mold complicated, thus leading to an increase in cost, and requires an excessively long assembly time, thus leading to a reduction in productivity.

Furthermore, the conventional air vent 2 is problematic in that an additional space should be required to operate the wing link connecting the outer wings 2c to each other, so that a degree of freedom in designing the air vent 2 is low.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an air vent apparatus for a vehicle, in which a plurality of outer wings is integrally formed using a wing nozzle connecting edges of the outer wings to each other, and the integrated outer wings and a plurality of inner wings are coupled to a spacer defining one space, and the spacer is installed at a duct, thus eliminating the use of the wing link for connecting the outer wings to each other, therefore achieving a reduction in the number of parts, a reduction in cost, and a reduction in weight, in addition to reducing a mold cost and enhancing the degree of freedom in design.

In an aspect of the present invention, an air vent apparatus for a vehicle, may include an outer wing integrated with a wing nozzle, a plurality of inner wings coupled to each other via a wing link, a spacer to which the wing nozzle is fixedly coupled, the inner wings being rotatably coupled to the spacer, the spacer being rotatably coupled to the duct, and a knob coupled to the inner wings while being fitted to the outer wing, thus rotating the inner wings relative to the spacer.

The air vent apparatus may further include a duct cover coupled to a front edge of the duct to cover a front edge of the spacer and minimizing leakage of air through a gap between the duct and the spacer.

The outer wing is integrally connected at opposite ends thereof to an inner circumference of the wing nozzle having a shape of a circular ring.

A plurality of coupling protrusions is formed on an outer circumference of the wing nozzle, and a plurality of coupling grooves is formed in an inner circumference of the spacer so that the coupling protrusions are fitted into corresponding coupling grooves.

The wing nozzle is airtightly coupled to the spacer to minimize leakage of air between the wing nozzle and the spacer.

A hinge protrusion is formed on each of upper and lower ends of the inner wings, and a hinge groove is formed in the spacer so that the hinge protrusion is rotatably inserted into the hinge groove.

The spacer is formed in a cylindrical shape to allow the spacer to rotate relative to the duct while being in close contact with the duct, and the duct is provided with a cylindrical seat.

A rotating shaft protrusion is formed on an outer surface of each of left and right sides of the spacer to allow the spacer to rotate up and down relative to the duct, and a rotating shaft hole is formed in the duct to allow the rotating shaft protrusion to be rotatably fitted therein.

A wing insert groove into which the outer wing is fitted and a knob protrusion for coupling the knob to the inner wing are formed on the knob, and a wing rod is formed on the inner wing so that the knob protrusion is fitted and coupled thereto.

A sealing member is coupled to the cylindrical seat of the duct to reduce a gap between the duct and the spacer and thereby minimize the leakage of air.

The sealing member is made of non-woven fabric to reduce the gap between the duct and the spacer while allowing for rotation of the spacer.

As is apparent from the above description, the air vent apparatus for the vehicle is advantageous in that the plurality of outer wings is integrated with the wing nozzle using the circular ring shaped wing nozzle, thus eliminating the use of the wing link for connecting the outer wings, therefore achieving a reduction in the number of parts, a reduction in cost, and a reduction in weight, and in that the wing link for the outer wings having a complicated assembling structure is not used, thus reducing a mold cost and enhancing the degree of freedom in design.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A and 1B are views illustrating a conventional air vent.

FIGS. 2A and 2B are perspective views showing an air vent apparatus for a vehicle according to an exemplary embodiment of the present invention.

FIGS. 3A to 5 are exploded perspective views showing the air vent apparatus for the vehicle according to an exemplary embodiment of the present invention.

FIG. 6 is a sectional view taken along line I-I of FIG. 2B.

FIG. 7 is a sectional view taken along line II-II of FIG. 2B.

FIGS. 8A and 8B and FIGS. 9A to 9C are views illustrating an operation of the air vent apparatus according to an exemplary embodiment of the present invention, in which FIG. 8A shows a downward adjusted state, FIG. 8B shows an upward adjusted state, FIG. 9A shows a leftward adjusted state, FIG. 9B shows a rightward adjusted state, and FIG. 9C shows a closed state.

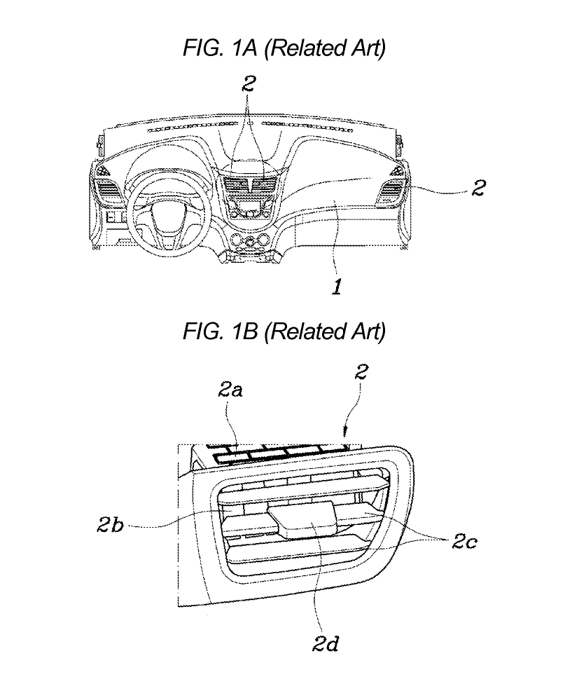

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinbelow, an air vent apparatus for a vehicle according to the preferred embodiment of the present invention will be described with reference to the accompanying drawings.

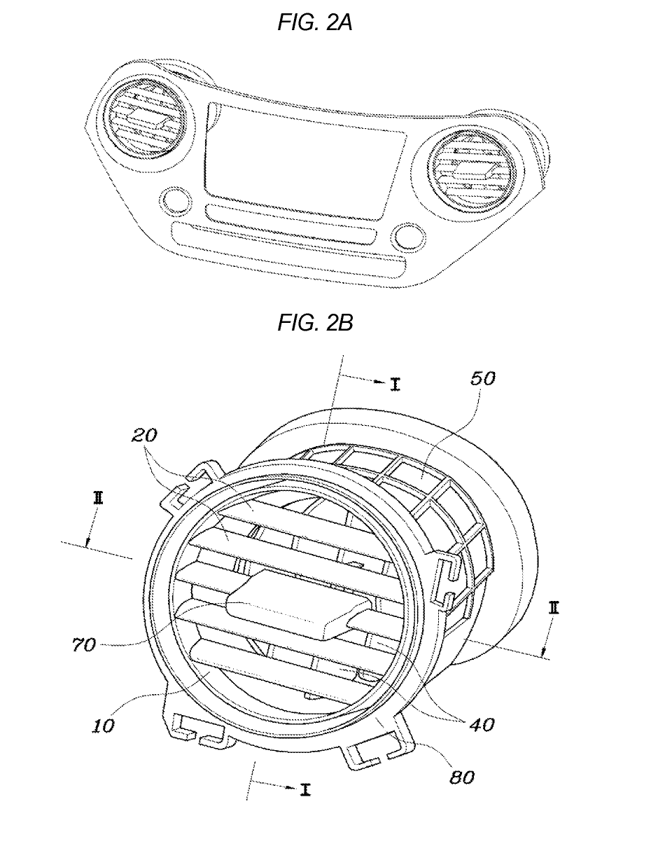

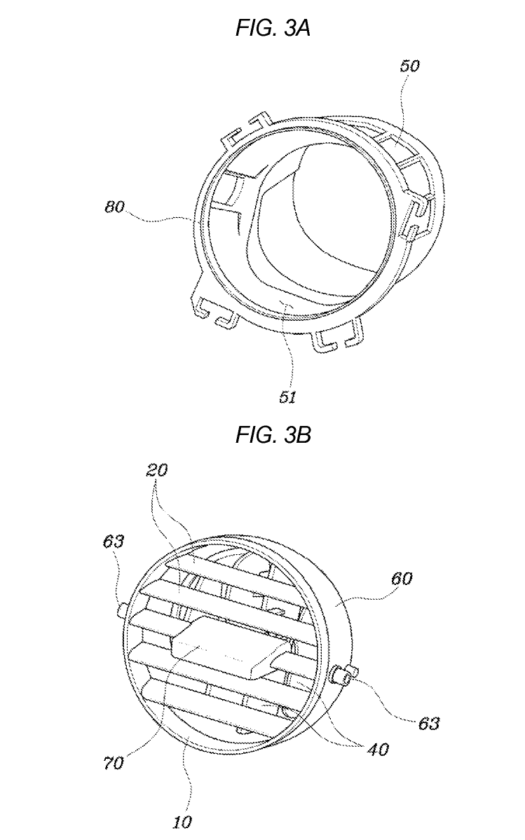

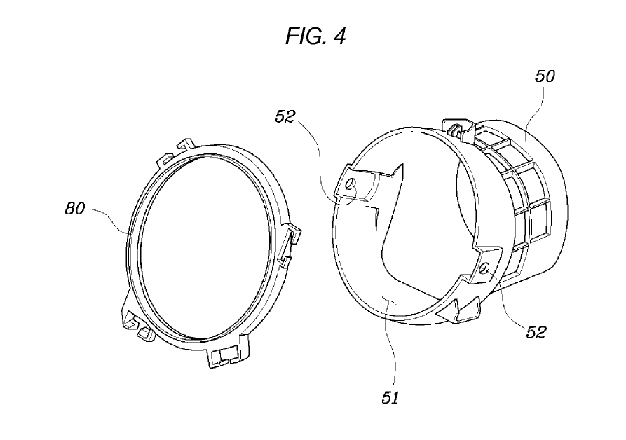

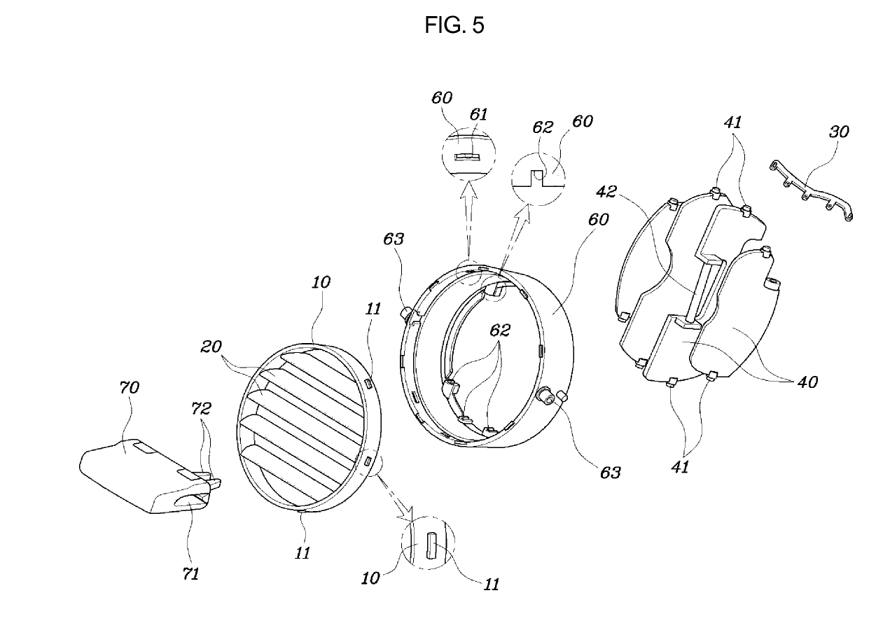

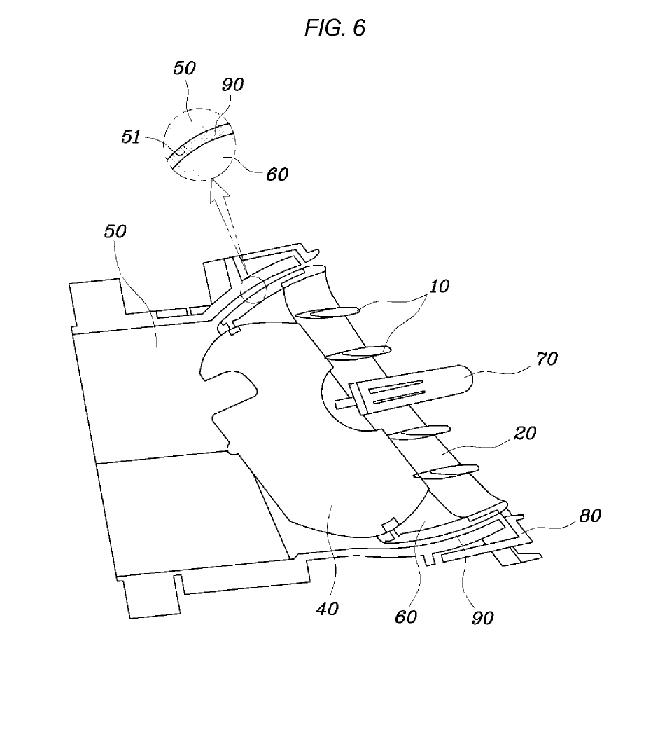

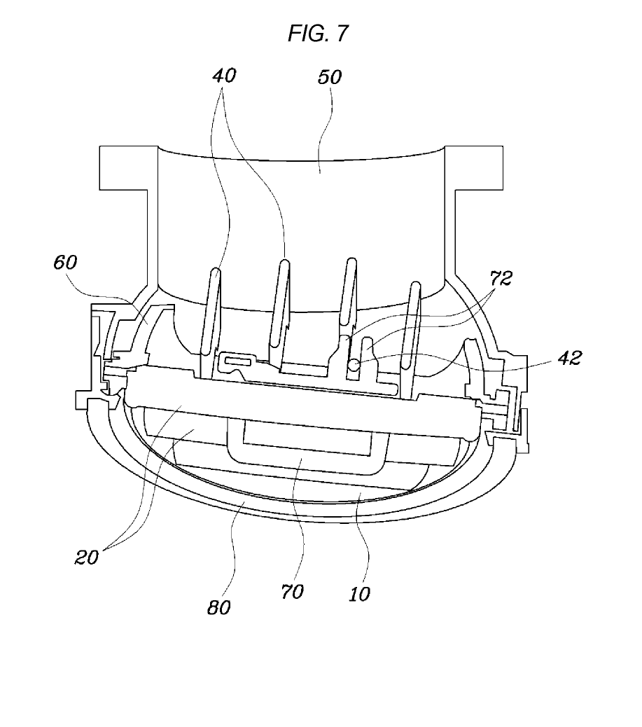

As shown in FIGS. 2A and 2B through FIGS. 9A to 9C, the air vent apparatus for the vehicle according to the present invention includes outer wings 20, a plurality of inner wings 40, a spacer 60, and a knob 70. The outer wings 20 are integrated with a wing nozzle 10. The inner wings 40 are connected to each other via a wing link 30. The wing nozzle 10 is fixedly coupled to the spacer 60, and the inner wings 40 are rotatably coupled to the spacer 60. The spacer 60 is rotatably coupled to the duct 50. The knob 70 is coupled to the inner wings 40 while being fitted to the outer wings 20, thus rotating the inner wings 40 relative to the spacer 60.

The air vent apparatus for the vehicle according to the present invention further includes a duct cover 80 which is coupled to a front edge of the duct 50 to cover a front edge of the spacer 60 and to minimize leakage of air through a gap between the duct 50 and the spacer 60.

The outer wings 20 are a plurality of horizontal wings which are arranged one above the other to be spaced apart from each other. The inner wings 40 are a plurality of vertical wings which are arranged next to each other to be spaced apart from each other and are rotated leftwards and rightwards.

The wing nozzle 10 is formed in a circular ring shape, and each outer wing 20 is integrally connected at opposite ends thereof to an inner circumference of the wing nozzle 10.

For the installation of the outer wings 20, a plurality of coupling protrusions 11 is formed on an outer circumference of the wing nozzle 10 to be spaced apart from each other in a circumferential direction, and a plurality of coupling grooves 61 is formed on the inner circumference of the spacer 60 so that the coupling protrusions 11 are fitted and coupled thereto.

In order to prevent the wing nozzle 10 from being removed from the spacer 60, the coupling protrusions 11 are preferably force fitted into the coupling grooves 61. If necessary, an additional coupling member may be provided to couple the wing nozzle 10 with the spacer 60.

Preferably, the wing nozzle 10 is air-tightly coupled to the spacer 60 so as to minimize the leakage of air between the wing nozzle 10 and the spacer 60. To this end, the wing nozzle 10 is preferably in surface contact with the spacer 60.

For the installation of the inner wings 40, hinge protrusions 41 are formed on upper and lower ends of each inner wing 40, while hinge grooves 62 are formed in the spacer 60 so that the hinge protrusions 41 are rotatably inserted into the hinge grooves 62.

The spacer 60 is formed in the cylindrical shape to rotate relative to the duct 50 while being in close contact with the duct 50. A cylindrical seat 51 is provided on the inner circumference of an end of the duct 50 to allow the spacer 60 to be rotatably seated thereon.

In order to couple the spacer 60 to the duct 50 in such a way as to be rotated up and down, rotating shaft protrusions 63 are formed on outer surfaces of left and right sides of the spacer 60, and rotating shaft holes 52 are formed in the duct 50 to allow the rotating shaft protrusions 63 to be rotatably fitted therein.

Further, a wing insert groove 71 into which the outer wing 20 is fitted and a knob protrusion 72 for coupling the knob 70 to the inner wing 40 are formed on the knob 70, and a wing rod 42 is formed on the inner wing 40 so that the knob protrusion 72 is fitted and coupled thereto.

A sealing member 90 is coupled to the cylindrical seat 51 of the duct 50 to reduce the gap between the duct 50 and the spacer 60 and thereby minimize the leakage of air. The sealing member 90 is preferably made of non-woven fabric to reduce the gap between the duct 50 and the spacer 60 while allowing for easy rotation of the spacer 60, but is limited thereto.

An operation of the air vent apparatus for the vehicle according to the embodiment of the present invention will be described below.

The air vent apparatus for the vehicle according to the present invention is configured such that the wing nozzle 10 is integrated with the outer rings 20. The wing nozzle 10 is coupled to the spacer 60 to be integrally operated. Since the spacer 60 is assembled with the duct 50 in such a way as to be rotated up and down relative to the duct 50, the spacer 60 has to rotate relative to the duct 50 so as to adjust the direction of air using the outer wings 20.

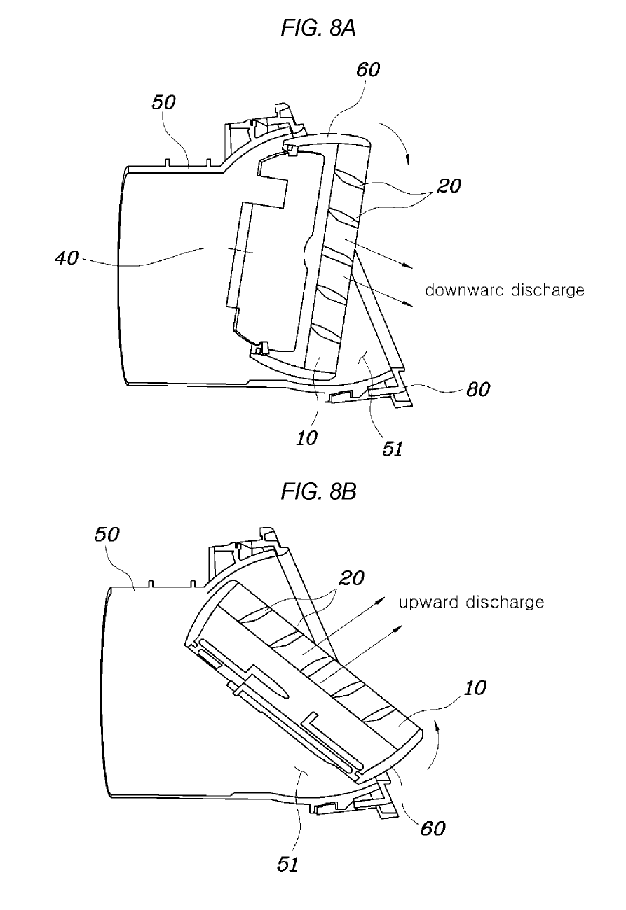

In other words, if the spacer 60 is rotated downwards as shown in FIG. 8A, using the rotating shaft hole 52 formed in the duct 50 and the rotating shaft protrusion 63 formed on the spacer 60, air is discharged downwards. By contrast, if the spacer 60 is rotated upwards as shown in FIG. 8B, air is discharged upwards.

According to the present invention, the plurality of inner wings 40 may be integrally operated via the wing link 30. Each inner wing 40 is rotatable leftwards and rightwards by fitting the hinge protrusions 41, provided on the upper and lower ends of the inner wing 40, into the hinge grooves 62 of the spacer 60. Since any one of the inner wings 40 is connected to the knob 70, the knob 70 is manipulated to adjust the direction of air using the inner wings 40.

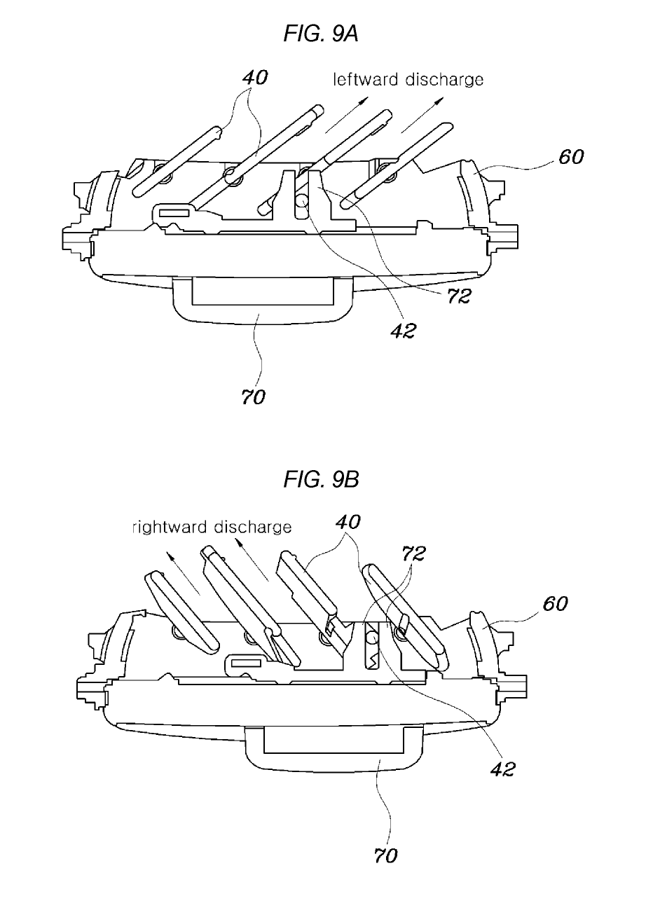

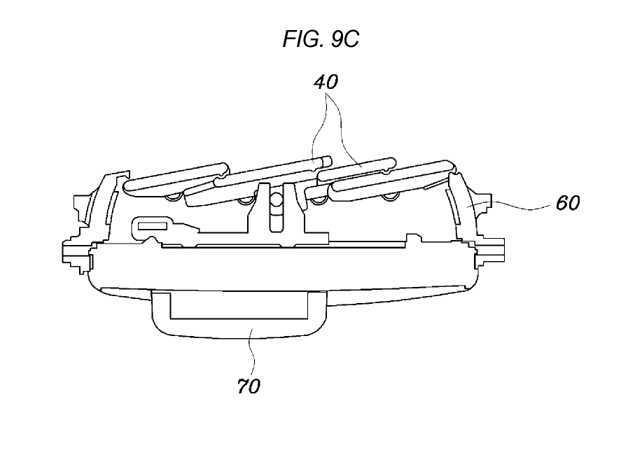

That is, if the knob 70 is moved leftwards from a position of FIGS. 2A and 2B, the inner wing 40 rotates leftwards about the hinge protrusion 41 as shown in FIG. 9A. In this case, air is discharged leftwards. In contrast, if the knob 70 is moved rightwards from a position of FIGS. 2A and 2B, the inner wing 40 rotates rightwards about the hinge protrusion 41 as shown in FIG. 9B. In this case, air is discharged rightwards.

Further, if the knob 70 is moved from a position of FIGS. 2A and 2B to a leftmost position, the plurality of inner wings 40 overlap each other to be closed as shown in FIG. 9C. In this case, air is not discharged to the interior of the vehicle.

As described above, the present invention provides an air vent apparatus for a vehicle, in which a plurality of outer wings is integrated with a wing nozzle using the circular ring shaped wing nozzle, thus eliminating the use of a wing link for connecting the outer wings unlike the related art, therefore achieving a reduction in the number of parts, a reduction in cost, and a reduction in weight, and in which the wing link for the outer wings having a complicated assembling structure is not used, thus reducing a mold cost and enhancing the degree of freedom in design.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An air vent apparatus for a vehicle, comprising:
an outer wing integrated with a wing nozzle;
a plurality of inner wings coupled to each other via a wing link;
a spacer to which the wing nozzle is fixedly coupled, the inner wings being rotatably coupled to the spacer, the spacer being rotatably coupled to the duct; and
a knob coupled to the inner wings while being fitted to the outer wing, thus rotating the inner wings relative to the spacer.

2. The air vent apparatus as set forth in claim 1, further comprising:
a duct cover coupled to a front edge of the duct to cover a front edge of the spacer and minimizing leakage of air through a gap between the duct and the spacer.

3. The air vent apparatus as set forth in claim 1, wherein the outer wing is integrally connected at opposite ends thereof to an inner circumference of the wing nozzle having a shape of a circular ring.

4. The air vent apparatus as set forth in claim 1, wherein a plurality of coupling protrusions is formed on an outer circumference of the wing nozzle, and a plurality of coupling grooves is formed in an inner circumference of the spacer so that the coupling protrusions are fitted into corresponding coupling grooves.

5. The air vent apparatus as set forth in claim 1, wherein the wing nozzle is airtightly coupled to the spacer to minimize leakage of air between the wing nozzle and the spacer.

6. The air vent apparatus as set forth in claim 1, wherein a hinge protrusion is formed on each of upper and lower ends of the inner wings, and a hinge groove is formed in the spacer so that the hinge protrusion is rotatably inserted into the hinge groove.

7. The air vent apparatus as set forth in claim 1, wherein the spacer is formed in a cylindrical shape to allow the spacer to rotate relative to the duct while being in close contact with the duct, and the duct is provided with a cylindrical seat.

8. The air vent apparatus as set forth in claim 1, wherein a rotating shaft protrusion is formed on an outer surface of each of left and right sides of the spacer to allow the spacer to rotate up and down relative to the duct, and a rotating shaft hole is formed in the duct to allow the rotating shaft protrusion to be rotatably fitted therein.

9. The air vent apparatus as set forth in claim 1, wherein a wing insert groove into which the outer wing is fitted and a knob protrusion for coupling the knob to the inner wing are formed on the knob, and a wing rod is formed on the inner wing so that the knob protrusion is fitted and coupled thereto.

10. The air vent apparatus as set forth in claim 7, wherein a sealing member is coupled to the cylindrical seat of the duct to reduce a gap between the duct and the spacer and thereby minimize the leakage of air.

11. The air vent apparatus as set forth in claim 10, wherein the sealing member is made of non-woven fabric to reduce the gap between the duct and the spacer while allowing for rotation of the spacer.
